(19) United States
(12) Patent Application Publication
(10) Pub. No.: US 2008/0230972 A1
(43) Pub. Date: Sep. 25, 2008

(54) Pipe holding or manipulating tool

(76) Inventor: Robert F. Ganley, Wayne, PA (US)

Correspondence Address: THE MATTHEWS FIRM, 2000 BERING DRIVE, SUITE 700, HOUSTON, TX, 77057, US

(21) Appl. No.: 12/009,046

(22) Filed: Jan. 16, 2008

Related U.S. Application Data
(60) Provisional application No. 60/896,673, filed on Mar. 23, 2007.

(51) Int. Cl. B25B 5/00; B25B 5/16

(52) U.S. Cl. 269/256; 269/287

(57) ABSTRACT

A pipe tool with a base unit and peripheral components for holding or manipulating pipe sections. The peripheral components allow the pipe tool to be configured for holding pipes of various sizes in alignment so they may be welded at a seam. The tool can also be reconfigured for changing the cross sectional shape of a deformed pipe end or for spreading open objects such as valve or pipe flanges.

### RELATED APPLICATIONS

This application claims priority from provisional application No. 60/896,673 filed on Mar. 23, 2007 and entitled “Pipe Alignment Tool.” Provisional application No. 60/896,673 is hereby incorporated by reference in its entirety.

### TECHNICAL FIELD

The present invention relates to the field of pipes and pipe welding. More specifically, the present invention relates to a tool for holding or manipulating sections of pipe.

### SUMMARY OF THE INVENTION

The present invention provides a portable, handheld tool for holding or manipulating pipes. Various embodiments of the present invention, which will be described in greater detail, can be used to hold pipes in alignment, reshape pipe ends, or separate pipe flanges. The base of the tool comprises a stationary portion and an adjustable portion, the adjustable portion being movable relative to the stationary portion. Different components may be attached to the stationary and adjustable portions to utilize their relative movement for different functions. In one embodiment, the tool is configured with a clamp for holding pipe sections into alignment. By way of a non-limiting example, the clamp may comprise a first member connected with the stationary portion of the tool for receiving two pipe sections and additional members connected with the adjustable portion of the tool for securing the pipe sections against the first member. In another embodiment, the tool is configured to reshape the end of a pipe section or to hold two pipe sections in alignment by tightening a chain around the end of a pipe section. By way of a non-limiting example, chain securing members, in the form of chain blocks, are attached to each of the stationary and adjustable portions of the tool for holding a portion of the chain. The chain may be wrapped around a pipe, section and tightened through the manipulation of the adjustable portion. In yet another embodiment the tool is configured for separating pipe flanges or valve flanges. By way of a non-limiting example, wedge shaped components are attached to each of the stationary and adjustable portions of the tool. These components can be aligned and forced in between two objects to be separated. The adjustable portion is then manipulated to force the two objects apart. Each of the embodiments as described in the specification and in the claims provides an innovative solution to problems not addressed or recognized by the prior art.

### BRIEF DESCRIPTION OF DRAWINGS

FIG. 1 is a perspective view of a pipe holding or manipulating tool for welding pipe ends together consistent with the present invention.

FIG. 2 is an exploded view of an assembly for translating rotational movement into linear movement consistent with the present invention.

FIG. 3 is an assembly view of a pipe holding or manipulating tool for welding pipe ends together consistent with the present invention.

FIG. 4A is front perspective of a pipe holding or manipulating tool for welding pipe ends together consistent with the present invention.

FIG. 4B is a front view of a pipe holding or manipulating tool for welding pipe ends together consistent with the present invention

FIG. 5 is an assembly view of a pipe holding or manipulating tool for separating members consistent with the present invention.

FIG. 6A is an isometric view of an actuating member consistent with the present invention.

FIG. 6B is an isometric view of an actuating member utilizing the chain embodiment consistent with the present invention.

### DETAILED DESCRIPTION OF EMBODIMENTS OF THE INVENTION

For a further understanding of the nature and objects of the present invention, reference should be made to the following detailed description, taken in conjunction with the accompanying drawings.

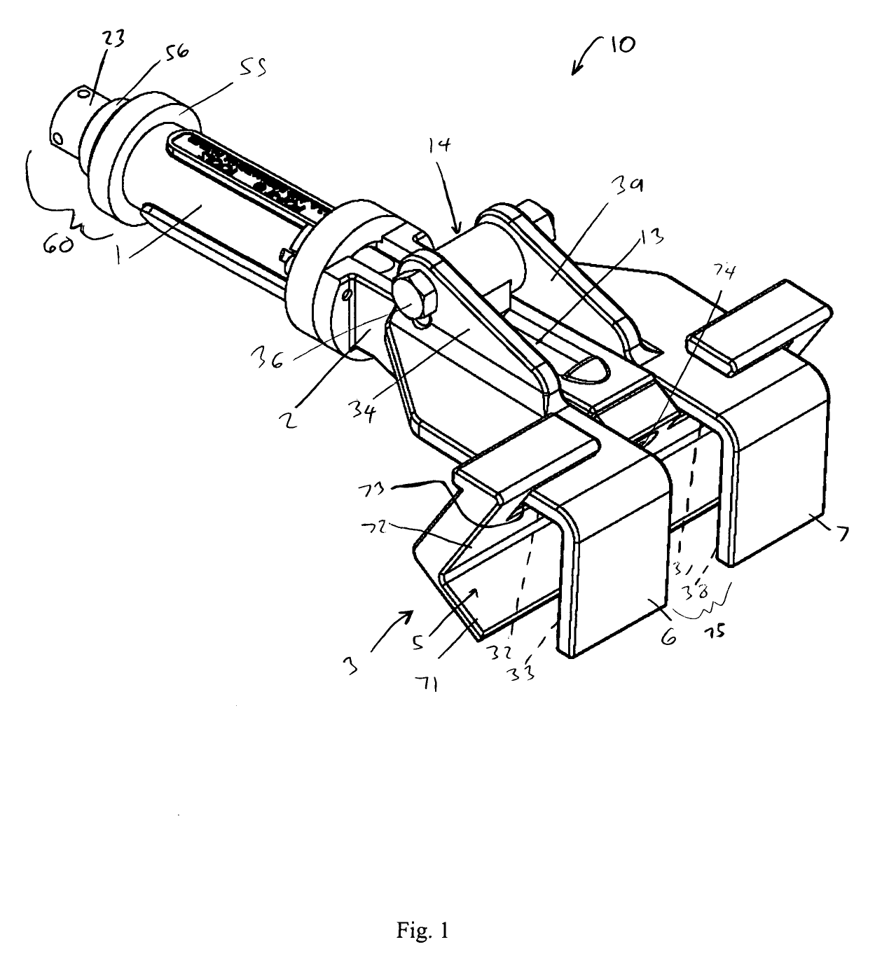

The present invention relates to a multipurpose tool for the manipulation of pipe sections. FIG. 1 illustrates one aspect of the pipe holding or manipulating tool for holding two pipe sections in alignment. In the field of pipe welding, firmly and accurately aligning two ends of separate pipe sections provides a continuous and straight section after welding. The pipe manipulating tool 10 illustrated in FIG. 1 enables two adequately supported pipe sections to be held in alignment once they are brought into abutting contact. Pipe tool 10 provides a relatively light tool requiring only one adjustment to secure both pipe sections into accurate alignment. The tool 10 has a stationary portion and an adjustable portion for clamping pipe sections once they are in alignment. A base 5 for receiving pipe sections is attached to a stationary portion of the tool 10, and fingers (6 and 7) are attached to the adjustable portion. The adjustable portion, or an actuating member 14, can be manipulated to draw each finger (6 and 7) uniformly towards the base 5. In this way, fingers 6 and 7 each clamp one of the two pipe sections against the base 5.

Pipe manipulating tool 10 comprises a cylinder 1 connected to a slotted member 2 for adjusting a clamp 3. A first finger 6 and a second finger 7 of the clamp 3 move in a linear fashion relative to the fixed base 5 of the clamp 3. As will be described in greater detail, this linear motion begins by rotating a drive screw 23 contained within a rotation assembly 60. As used herein the term rotation assembly is intended to refer to a collection of parts wherein at least one of those parts is capable of rotation relative to the other parts. The rotation assembly 60 described herein should be appreciated as a non-limiting example for imparting linear motion to the actuating member 14. The present invention contemplates other mechanical means for imparting motion to the actuating member 14 as well as other hydraulic or electromechanical means. For example, actuating member 14 may be pushed by a solid member, or by fluid or gas pressure. As illustrated by way of example in FIG. 1 the drive screw 23 is a member free to rotate fixed to the end of the cylinder 1. When two pipe sections are inserted between the fingers (6 and 7) and the fixed base 5, rotation of the drive screw 23 tightens or loosens the clamp's 3 grip on the pipe sections.

The external surface of the cylinder 1 comprises ridges or extrusions, which can provide an improved surface for gripping the pipe tool 10 during operation. Internally, the cylinder 1 houses the drive screw 23 in a central cavity. Only the top most portion of the drive screw 23 is visible in FIG. 1. The drive screw 23 is rotatably fixed to the top portion of the cylinder 1 through a thrust bearing 56 and an end cap 55. Drive screw 23 rotates freely through the thrust bearing 56 and end cap 55. The drive screw 23 threads into a first actuating member 14 contained at least partially within the slotted member 2. The first actuating member 14 resides at least partially within a central cavity of the slotted member 2. A portion of the first actuating member 14, referred to as the attachment piece 16, extends through a slot 13 in the slotted member 2. The first actuating member 14 contains a shaft 20 (not visible in FIG. 1), which is threadably connected to the drive screw 23. The first actuating member 14 is not free to rotate with the drive screw 23. Therefore, any rotation of the drive screw 23 results in drive screw 23 threading further into or out of the first actuating member 14. Because the drive screw 23 is fixed relative to the body of the pipe tool 10 this threading results in the linear displacement of the actuating member 14 relative to the body of the pipe tool 10. Clockwise rotation of the drive screw 23 results in the drive screws 23 threading into the first actuating member 14 and the first actuating member 14 being pulled linearly towards the top of the cylinder 1.

Referring again to FIG. 1, the clamp 3 can be seen at the bottom of the slotted member 2. The clamp 3 comprises the fixed base 5 as well as the first finger 6 and the second finger 7. The fixed base 5 along with the first finger 6 and the second finger 7 provide a surface for clamping pipe sections. Fixed base 5 is generally “V” or “L” shaped allowing the base 5 to better grip generally cylindrical pipe sections. This shape provides a first gripping surface 71 in the fixed base 5 and a second gripping surface 72 in the fixed base 5. Removable screws 74 rigidly attach fixed base 5 to the bottom of the slotted member 2. The fixed base 5 is easily removable and the pipe tool 10 may include fixed bases of different sizes to accommodate different sized pipes. A slot 73 provided in the fixed base 5 is shaped to receive a first finger 6 and a second finger 7 so the fingers are in a slidable engagement with the fixed base 5.

The first finger 6 comprises a first pipe gripping surface 32 and a second pipe-gripping surface 33 for gripping a section of pipe. Each gripping surface may be textured to help prevent rotation of pipe sections being held. The first finger 6 also comprises a connection plate 34 with a through hole for attachment to the attachment piece 16. The second finger 7 comprises a first pipe gripping surface 37 and a second pipe-gripping surface 38 for gripping another section of pipe. The second finger also comprises a connection 39 plate with a through hole for attachment to the attachment piece 16. The first griping surface 32 and the second gripping surface 33 may be formed at roughly a 90 degree angle by bending a single member, as are the first gripping surface 37 and the second gripping surface 38 of the second finger 7. Those of ordinary skill in the art would appreciate different angles could be implemented so long as both fingers are uniform to facilitate holding separate pipe section in alignment. Bolt 36 attaches the connection plate of each finger to the attachment piece 16 of the first actuating member 14. Because of this rigid connection, linear displacement of the first actuating member 14 results in the uniform linear movement of the first finger 6 and the second finger 7 relative to the fixed base 5. In this way, rotation of the drive screw 23 in the clockwise direction tightens the grip of the clamp 3 by pulling the first actuating member 14 and the fingers 6 and 7 closer to fixed base 5. Counterclockwise rotation of the drive screw 23 loosens the grip of the clamp 3 by moving fingers 6 and 7 away from fixed base 5. To assure pipe sections are held in alignment, both fingers are uniform in dimension and shape. Additionally, they are attached symmetrically to the first actuating member 14. This configuration ensures the two pipe sections can be held into close alignment with minimal adjustments made on the pipe tool 10. In use, the first finger 6 would grip a first pipe section against the fixed base 5 and the second finger 7 would grip a second pipe section against the fixed base 5. The seam between the pipe sections is lined up in the gap between the first finger 6 and the second finger 7 to permit access for welding.

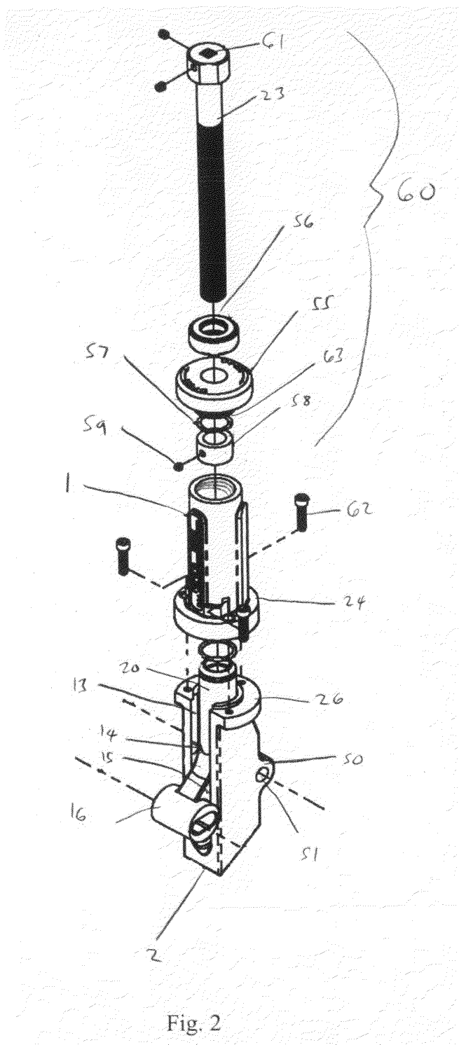

FIG. 2 illustrates the body of the pipe tool 10, comprising the cylinder 1 and the slotted member 2 as well as the rotation assembly 60 and the first actuating member 14, both disposed partially within the body. One of ordinary skill in the art would appreciate different shapes and configurations for the body. For instance, the rotation assembly 60 could be configured to be disposed entirely within the body. By way of a non-limiting example, three screws 62 are illustrated for connecting a bottom flange 24 of the cylinder 1 with the top flange of lip 26 in a slotted member 2. These pieces may be bolted together, threaded together, or connected in another manner known to those in the art. The pieces may be glued or welded together, but in one aspect it is preferred the cylinder 1 and the slotted member 2 are releasably connected to facilitate changing the tools configuration.

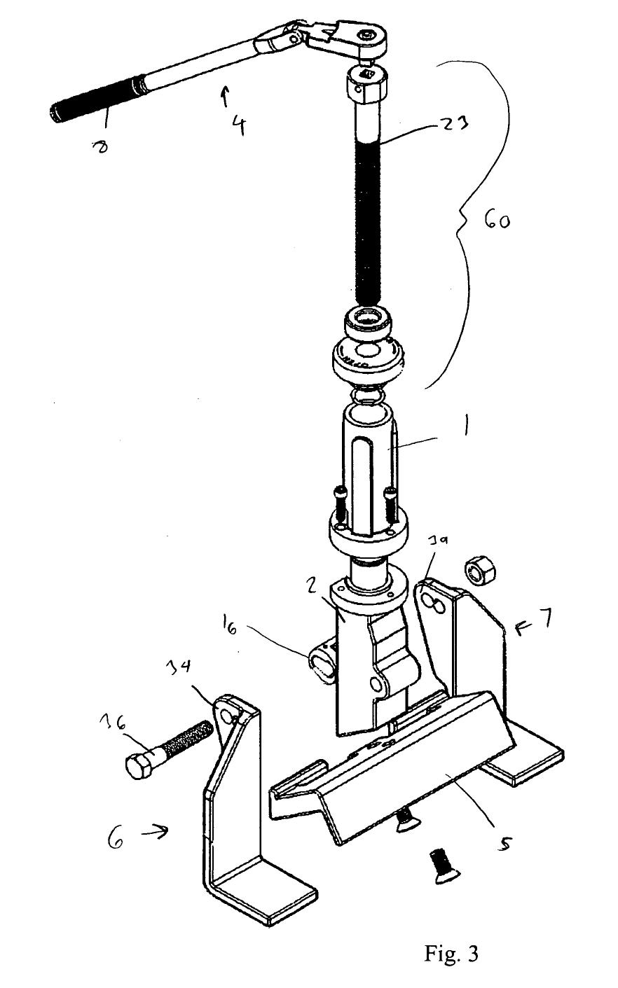

The rotation assembly 60 and the first actuating member 14 are at least partially disposed within the central cavity of the cylinder 1 the central cavity of the slotted member 2. The rotation assembly 60 comprises the drive screw 23 rotatably disposed through the thrust bearing 56, the end cap 55, a washer 57 and a locking sleeve 58. A setscrew or pin 59 locks the locking sleeve 58 to rotate with the drive screw 23. Different configurations of the rotation assembly 60 could be employed and this discussion relates to one illustrative example. Functionally, the rotation assembly 60 prevents the linear displacement of the drive screw 23, while allowing the drive screw 23 to rotate freely. One of ordinary skill would appreciate other configurations for accomplishing the same function. A slot 61 in the head of the drive screw 23 is designed for receiving a ratchet as shown in FIG. 3. The ratchet rotates the drive screw 23 to tighten and loosen the clamp assembly 3 as described. A ratchet provides light, portable means for operating the pipe tool, but one of ordinary skill in the art would appreciate other means, such as powered means, would work equally well for rotating the drive screw 23. End cap 55 comprises a threaded portion 63 so it may be threaded into the top of cylinder 1. Drive screw 23 is inserted through the thrust bearing 56 and the end cap 55 so that the head of drive screw 23 rests on the thrust bearing 56. Beneath the end cap 55, drive screw 23 is disposed through the washer 57 and locking sleeve 58. The locking sleeve 58 is set to rotate with the drive screw 23 and lock drive screw 23 into engagement against the end cap 55. A pin set screw 59 in the locking sleeve 58 locks the locking sleeve 58 on the drive screw 23 and is placed against the end cap 55 in order to prevent the drive screw 23 from linear displacement out of the end cap 55. The diameter of the head of the drive screw 23 limits the drive screw 23 from sliding through the trust bearing 56 or end cap 55, and the diameter of the locking sleeve 58 prevents the drive screw 23 from being pulled out of the rotation assembly 60. In this way, the drive screw 23 rotates freely relative to the end cap 55 and thrust bearing 56 while being secured against linear displacement relative into or out of the end cap 55. Once the end cap 55 is secured into the top of the cylinder 1, the drive screw 23 is disposed to rotate freely within the cylinder 1, but is locked into position to prevent linear displacement of the drive screw 23 relative to the end cap 55 or the cylinder 1.

The slotted member 2 has a central cavity which houses the adjustable member 14. A shaft 20 of the adjustable member 14 freely moves in a linear manner within the central cavity of the slotted member 2. A neck 15 of the adjustable member 14 passes through a slot 13 in the slotted member 14. The neck 15 connects to an attachment piece 16 outside of the slotted member 2 and the shaft 20 of the adjustable member 14. The body of the slotted member 2 has a protrusion 50 in its otherwise relatively flat surface on the side of the slotted member 2 opposite the slot 13. The protrusion 50 has a through hole 51 which may or may not be threaded. A pipe tool handle (not pictured) may be attached at the through hole 50 to provide an addition grip for an operator manually operating the pipe tool 10. The tool handle may be threaded on one end so that it can be secured into through hole 51 or secured with nuts to the slotted member 2.

Within the central cavities of the cylinder 1 and the slotted member 2, the end of drive screw 23 is threaded into the top of shaft 20. When rotated, the drive screw 23 threads further into the shaft 20, or unthreads depending on the direction of rotation. As the first actuating member 14 and the drive screw 23 become further engaged, the first actuating member 14 is pulled in the linear direction towards the top of the cylinder 1. First finger 6 and second finger 7, as previously described, would be pulled towards the cylinder 1 through their attachment at the attachment piece 16 resulting in the clamp tightening. Counterclockwise rotation of the drive screw 23 backs the drive screw 23 out of the first actuating member 14 and pushes the first actuating member 14 away from the cylinder 1. In this manner the first finger 6 and the second finger 7 are pushed away from the cylinder 1 and the clamp assembly 3 loosens its grip. The slot in the slotted member 2 limits movement of the first actuating member 14. For instance, the neck 15 of the actuating member 14 will reach the bottom of the slot and contact the slotted member 2 before the first actuating member 14 becomes unthreaded from the drive screw 23.

In FIG. 3, a ratchet 4 can be seen for rotating drive member 23. The ratchet handle 8 allows for easy manual use, but other sources of power may not require the mechanical advantage provided by the ratchet 4. The first finger 6 and the second finger 7 can be seen more clearly in FIG. 3 as generally L-shaped with additional extensions, or connection plates 34, for mounting with the attachment piece 16. Bolt 36 rigidly secures both the connection plate 34 of first finger 6 and the connection plate 39 of the second finger 7 to the attachment piece 16 of the adjustment member 14.

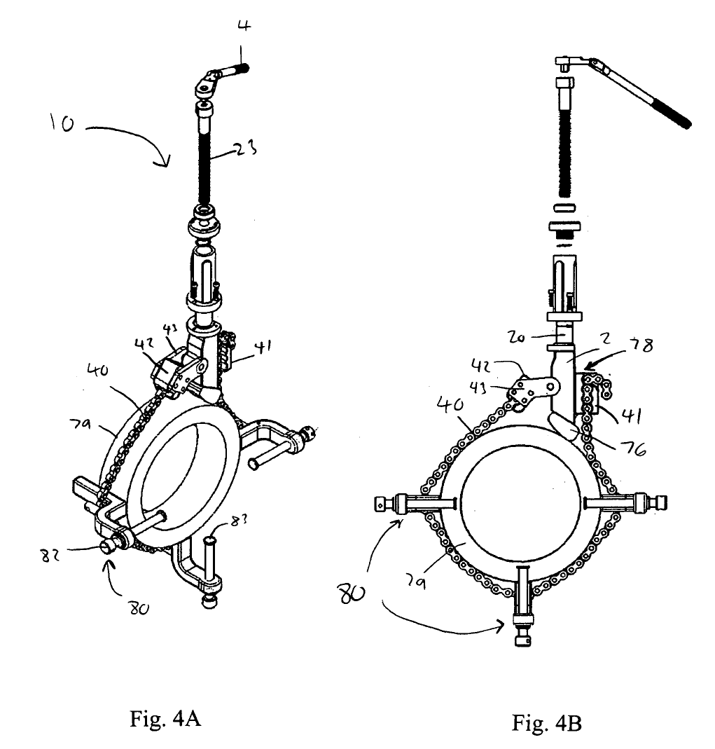

FIGS. 4A and 4B illustrate a second embodiment of the pipe tool configured to hold larger pipes in alignment. By interchanging several pieces, the pipe tool used for pipe holding and alignment becomes a tool that can be used for aligning larger pipes as well as a tool for reshaping pipes. The cylinder 1 contains the same rotation assembly 60 previously discussed and is attached to the slotted member 2 in the same manner. However, the first actuating member 14 is replaced with a second actuating member 78 of a different design. The second actuating member 78 comprises a shaft 20, which is threaded to the drive screw 23 of the rotation assembly 60. Rotation of the drive screw 23 likewise results in the linear movement of the second actuating member 78 relative to the slotted member 2 and cylinder 1. The clamp assembly 3, including the two fingers and the fixed base 5, is removed from the body of the pipe tool 10. In place of the fixed base 5, a toe 76 is screwed onto the bottom portion of the slotted member 2. In place of the first finger 6 and the second finger 7, a chain block 41 is mounted with the second actuating member 78. The neck 15 of the second actuating member 78 connects the second actuating member 78 with the first chain block 41. The first chain block 41 is a rigid block with a chain profile 45 cut away. A chain 40 can be easily slid into and out of the profile 45 from the side. However, the profile 45 is snuggly shaped around the links of the chain 40 so that once in the first chain block 41, tension will not displace the chain 40 through the ends of the first chain block 41. It should be noted a chain has been illustrated, however, the current invention contemplates generally a flexible tension member, which includes chains, ropes, cables, straps, or other tensile structures flexible enough to be wrapped around a pipe. It should be further appreciated the present invention is illustrated with chain blocks for holding chains by their profile. However, the present invention contemplates other means for securing flexible tension members such as hooks, loops, teeth and other means for securing flexible tension member profiles or links. The term securing member shall be understood to encompass the chain blocks as illustrated in addition to hooks, loops, teeth and other means for securing flexible tension member profiles or links. It should be noted that while the illustrations show a first actuating member 14 and a second actuating member 78, the same actuating member may be adapted for use in both configurations. In order to use the same actuating member in both configurations the first chain block 41 would be connected to the first actuating member 14 through the attachment piece 16 of the first actuating member 14.

In this configuration, the though hole 51 of the slotted member is utilized to pivotably mount a chain block bracket 43. A second chain block 42 is secured within the chain block holder and is therefore also pivotably connected at the through hole 51. A first end of the chain 40 would typically be slid into the second chain block 42 before the second chain block is mounted in the chain block bracket 43. The sides of the bracket 43 serve to keep the chain 40 from sliding out the side of the second chain block 42. Like the first chain block 41, a profile 47 fits tightly with the links of the chain 40 to prevent the chain 40 from being pulled through the ends of the second chain block 42.

In operation of this embodiment, the chain 40 is initially secured to the slotted member 2 through the second chain block 42 at the chain block bracket 43. The pipe tool 10 can then be lined up at one end of a first pipe section 79. The loose end of the chain 40 is wrapped around the pipe section 79 and over adjustment elements 80, sometimes known as “dogs.” Each adjustment element 80 comprises flat portions 81 for contacting the first pipe section 79 on one side and the chain 40 on the other. Each adjustment element 80 contains an adjustable pin 82 with a surface contacting area 83 for contacting a second pipe section. The adjustable pins 82 are threaded into the adjustment element 80 so the surface contacting area 83 can be moved in a linear manner. This is done at the end of a first pipe section 79, for instances at the end of a pipe section 79 to be welded. The other end of the chain 40 is then connected to the pipe tool 10 at the first chain block 41 by sliding the chain 40 into the profile 45 of the first chain block 41. While the chain 40 is preferably wrapped around the pipe section 79 with minimal slack, rotating the drive screw 23 clockwise pulls the second actuating member 78 and the first chain block 41 away from the pipe section 79 to tighten the chain 40 around the pipe and adjusting elements. In this way, the pipe tool 10 firmly secures several adjustment elements 80 around the first pipe section 79.

Once the chain 40 has secured adjustment elements 80 to a first pipe section 79, a second pipe section (not pictured) can be brought into contact with the end of the first pipe section 79. FIGS. 4A and 4B illustrate three adjustment elements 80 for fine-tuning the alignment of the second pipe section; however, more could be used. If both pipe sections are sufficiently supported, fewer than three adjustment elements 80 could be used. The first pipe section 79 is gripped into place firmly by the chain 40, and the second pipe section is adjusted into alignment with the first pipe section 79 by adjusting the adjustment pins 82. FIGS. 4A and 4B illustrate adjustment elements 80 shaped to curve away from the pipe sections near the seam between the pipe sections. This shape provides maximum access to the seam created between the two pipes for welding the pipe sections together.

The embodiment shown in FIGS. 4A and 4B can also be used to reshape the deformed ends of pipe sections. In order to reshape the deformed end of a pipe section, the chain 40 is wrapped around the pipe section, as described previously, except the adjustment members 80 are not secured between the chain 40 and the pipe section. The chain 40 is then tightened sufficiently around the pipe section so the force applied from the chain 40 to the end of the pipe tends to reform the pipe end into a more circular shape.

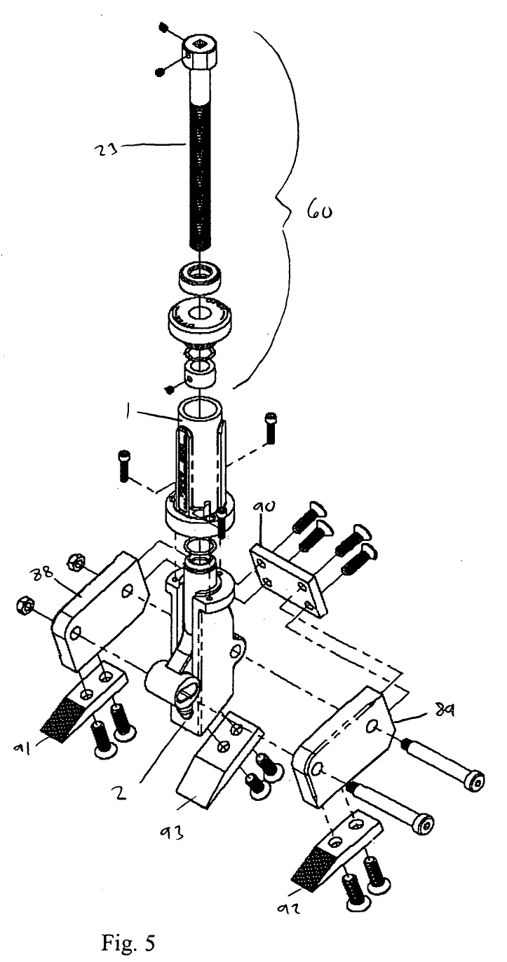

FIG. 5 illustrates an additional configuration of the pipe tool 10 for spreading open pipe flanges or for separating pipe flanges from valve flanges. In this configuration, the first actuating member 14 is connected to drive screw 23 of the rotation assembly 60 in the same manner as the first embodiment. The cylinder 1 and slotted member 2 are configured in the same manner as previously described. In place of the fixed base 5 of the first embodiment, an inside toe 93 is screwed into the bottom of the slotted member 2. A first side plate 88 is attached to the attachment piece 16 on one side and a second side plate 89 is attached to the attachment piece 16 on the other side. The first side plate 88 has a first outside toe 91 attached at its bottom and the second side plate 89 has a second outside toe 92 attached at its bottom. FIG. 5 illustrates each toe ending in a wedge shape, although this is not necessary. A striker plate 90 is attached to the back of the first side plate 88 and the second side plate 89.

In operation, the inside toe 93 can be aligned with the first outside toe 91 and the second outside toe 92 by rotation of the drive screw 23 and the resulting linear displacement of the actuating member 14. Once aligned, the three toes can be forced between two members to be separated. For instance, the pipe tool could be used to separate pipe flanges or to separate a pipe flange from the flange on a valve. The toes may be aligned according the size of the gap between the members to be separated. After an initial attempt to insert the wedge end of the toes into a gap or space, the pipe tool 10 can be struck on the strike plate 90 with a hammer to force the wedge end of each toe further into the gap. Once the gap has been sufficiently penetrated, the drive screw 23 is rotated to separate the inside toe 93, which is rigidly affixed to the body of the pipe tool 10, from the first outside toe 91 and the second outside toe 92, which are both mounted to move with the actuating member 14 through the attachment piece 16. In this way, the inside toe 93 exerts force on one of the two surfaces to be separated and first outside toe 91 and the second outside toe 92 exert force on the second surface to be separated in the opposite direction. These forces can serve to spread pipe flanges, for example.

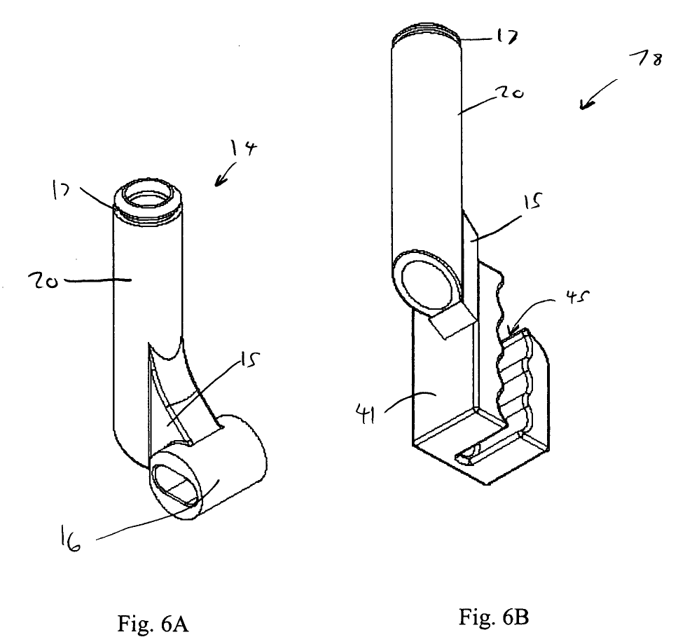

FIG. 6A illustrates a first actuating member 14. The first actuating member comprises a shaft 20. The shaft 20 is dimensioned to slide through the central cavities of the cylinder 1 and the slotted member 2. The shaft 20 also has an internal cavity for receiving the drive member 23 (not shown in FIG. 6A). At least a portion of the shafts 20 interior is threaded so it can threadably engage the drive screw 23. The shaft 20 connects neck 15 to the attachment piece 16 and contains a groove 17 for receiving an O-ring (not shown). The O-ring contacts the interior of the slotted member 2 or cavity of the cylinder 1 as the actuating member 14 moves up and down relative to the body of the pipe tool 10. The attachment piece 16 has a though hole for receiving various bolts used to secure attachments to the actuating member 14.

FIG. 6B illustrates an actuating member 79 for use with the embodiment of FIGS. 4A and 4B. The shaft 20 of the actuating member 79 is threaded for receiving a drive screw 23. The neck 15 of the actuating member 79 attaches to a chain block 41. FIG. 6B more clearly illustrates the profile 45 in the chain block. The profile 45 closely matches the chain 40 to be secured around a pipe section. The configuration of the profile 45 allows one end of a chain 40 to be easily slid into the chain block 41 from the open side. The profile prevents the chain in tension from being pulled out either end of the chain block 41.

This invention relates to a pipe tool for holding or manipulating pipes. Holding pipes, reshaping pipes, and separating objects, such as pipe flanges and valve flanges, as described herein are merely a few illustrative examples where the present invention provides an advantage, and the scope of the invention is not limited to such. It should be understood the illustrative examples depicted in the detailed description are not intended to limit the invention, which is defined by the claims attached hereto. It is apparent that changes and modifications may be made without departing from this invention in its broader aspects. Therefore, the claims which follow are intended to cover all changes and modifications that fall within the scope of the invention.

What is claimed is:

1. A pipe holding apparatus for holding two pipe sections into alignment while they are connected comprising:
a body;
a first actuating member disposed at least partially within the body for movement relative to the body; and
a clamp assembly including a first portion connected to the body and a second portion connected to the first actuating member, wherein movement of the first actuating member displaces the second portion of the clamp assembly relative to the first portion of the clamp assembly.

2. The pipe holding apparatus according to claim 1 wherein the body further comprises:
a rotation assembly disposed at least partially within the body and connected to the first actuating member, wherein rotation of at least a portion of the rotation assembly moves the first actuating member to displace the second portion of the clamp assembly relative to the first portion of the clamp assembly.

3. The pipe holding apparatus according to claim 2 wherein the body further comprises:
a cylinder with a central cavity, the cylinder connected to a slotted member with a
central cavity; and
a cap connected to the cylinder; and
the rotation assembly comprises:
a drive screw disposed at least partially within the body; and
a locking sleeve mounted with the drive screw, wherein the locking sleeve prevents linear displacement of the drive screw relative to the body.

4. The pipe holding apparatus according to claim 1 wherein the first actuating member comprises:
a shaft located within the slotted member;
a neck connected to the shaft which extends through a slot in the body; and
an attachment piece connected to the neck located outside the body,

5. The pipe holding apparatus according to claim 1 wherein the first portion of the clamp assembly comprises:
a fixed base mounted with the body; and
the second portion of the clamp assembly comprises:
a first finger mounted with an attachment piece of the first actuating member; and
a second finger mounted with the attachment piece of the first actuating member.

6. The pipe holding apparatus according to claim 5 wherein the first finger and the second finger are mounted substantially in parallel and spaced apart by the attachment piece.

7. The pipe holding apparatus according to claim 1 wherein first actuating member is interchangeable with a second actuating member and the second actuating member comprises:
a shaft located at least partially within the slotted member,
a neck connected to the shaft extending through a slot in the body; and
a first securing member located outside the body and connected to the neck, and wherein the clamp assembly is interchangeable with a first securing member mounted with the second actuating member, and a second securing member mounted with the body.

8. The pipe holding apparatus according to claim 7 wherein the first securing member is mounted for linear motion with the second actuating member and a first end of a flexible tension member is disposed with the first securing member, the second securing member is attached to the body and a second end of the flexible tension member is disposed within the second securing member, and rotation of the rotation assembly results in the linear displacement of the first securing member and tightens or loosens the flexible tension member disposed around a pipe.

9. The pipe holding apparatus according to claim 7 wherein the flexible tension member is a chain.

10. A pipe manipulating or holding tool comprising:
a body with a slot;
a rotation assembly disposed at least partially within the body;
an actuating member disposed at least partially within the body and connected with the rotation assembly, wherein at least a portion of the actuating member passes through the slot of the body; and
a first part mounted with the actuating member and a second part either rigidly affixed to or pivotably mounted with the body.

11. The pipe manipulating or holding tool according to claim 10 wherein the first part comprises:
a first finger; and
a second finger; and
the second part comprises:
a fixed base rigidly mounted with the body, wherein rotation of the rotation assembly creates linear movement between the first part and the second part for holding two separate pipe sections into alignment.

12. The pipe manipulating or holding tool according to claim 10 wherein the first part is a side plate connected to an outside toe and the second part is an inside toe, wherein rotation of the rotation assembly creates linear movement between the first part and the second part for separating objects.

13. The pipe manipulating or holding tool according to claim 10 wherein the first part is a first securing member for mounting with the actuating member and the second part is a securing member bracket for mounting a second securing member to the body, and wherein rotation of the rotation assembly creates linear movement between the first part and the second part for tightening a flexible tension member disposed around a pipe.

14. The pipe manipulating or holding tool according to claim 13 wherein the flexible tension member is connected around the end of a first pipe section and over adjustment members, and wherein the adjustment members serve to hold a second pipe section in alignment with the first pipe section.

15. The pipe manipulating or holding tool according to claim 10 wherein rotation of the rotation assembly creates a linear displacement of the actuating member so the second part moves relative to the body, while the first part remains stationary.

16. A pipe manipulating or holding tool comprising:
a body;
an actuating member disposed at least partially within the body for movement relative to the body; and
a first securing member mounted with the body;
a second securing member mounted with the actuating member; and
a flexible tension member for surrounding a pipe section, the flexible tension member mounted with the first securing member and the second securing member, wherein displacement of the actuating member tightens or loosens the flexible tension member around the pipe section.

17. The pipe manipulating or holding tool according to claim 16 wherein the body further comprises:
a rotation assembly disposed at least partially within the body and connected to the actuating member;
wherein rotation of at least a portion of the rotation assembly moves the actuating member to displace the second securing member relative to the first securing member to tighten the flexible tension member around the pipe section.

17. The pipe manipulating or holding tool according to claim 16 wherein the flexible tension member is displaced at an end of the pipe section and tightening the flexible tension member serves to reshape any deformations in the pipe end.

18. The pipe manipulating or holding tool according to claim 16 wherein the tool further comprises adjustment members and the adjustment members hold a second pipe section in alignment with the first pipe section.

19. The pipe manipulating or holding tool according to claim 17
wherein the body comprises a cylinder and a slotted member, and
wherein the rotation assembly comprises a threaded member threaded into the actuating member for imparting linear motion to the first securing member in order to tighten or loosen the flexible tension member around the pipe section.

20. The pipe manipulating or holding tool according to claim 16 wherein the first securing member and the second securing member are interchangeable with a clamp assembly, wherein a first portion of the clamp assembly is mounted for movement with the actuating member, wherein a second portion of the clamp assembly is rigidly mounted to the body, and wherein the movement of the actuating member tightens or loosens the tools grip on the pipe.

21. A pipe manipulating tool comprising:
a body;
a first actuating member disposed at least partially within the body for movement relative to the body; and;
a first toe rigidly mounted with the body; and
a second toe mounted with the first actuating member,
wherein displacement of the first actuating member imparts linear motion between the first toe and the second toe.

22. The pipe tool according to claim 21 further comprising:
a rotation assembly at least partially disposed within the body;
wherein rotation of the rotation assembly imparts linear motion to the first actuating member for displacing at least one toe relative to the body.

23. The pipe tool according to claim 21 wherein the first toe is interchangeable with a fixed base and the second toe is interchangeable with at least one finger, wherein the at least one finger and the fixed base form the jaws of a clamp for holding two pipe sections.

24. The pipe tool according to claim 22 wherein the second toe is interchangeable with a first securing member and the first toe is interchangeable with a second securing member, wherein a flexible tension member is disposed around a pipe section and has a first end disposed in the first securing member and the second end disposed in the second securing member, and rotating the rotation assembly tightens or loosens the chain around the pipe section.
